(19) United States
(12) Patent Application Publication
(10) Pub. No.: US 2020/0063027 A1
(43) Pub. Date: Feb. 27, 2020

(54) NANOMATERIALS STABILIZED EMULSIONS AS FRACTURING FLUID SYSTEM

(71) Applicant: Halliburton Energy Services, Inc., Houston, TX (US)

(72) Inventors: Prashant Chopade, Kingwood, TX (US); Rajender Salla, Pune (IN); Monica Rajendra Dandawate, Pune (IN)

(73) Assignee: Halliburton Energy Services, Inc., Houston, TX (US)

(21) Appl. No.: 16/090,711

(22) PCT Filed: Jun. 17, 2016
(86) PCT No.: PCT/US2016/038100

§ 371 Date: Oct. 2, 2018

(51) Int. Cl. C09K 8/82; C09K 8/80

(52) U.S. Cl. CPC C09K 8/82; C09K 2208/10; C09K 8/805

(57) ABSTRACT

A method of servicing a wellbore in a subterranean formation by providing a wellbore servicing fluid containing proppant particulates suspended in an oil external emulsion, wherein the oil external emulsion comprises an oleaginous external phase, an aqueous internal phase, a nanomaterial, and an emulsifier, and introducing the wellbore servicing fluid into the wellbore in the subterranean formation. A method of forming a wellbore servicing fluid by dispersing a nanomaterial in water, combining the aqueous dispersed nanomaterial with a proppant, an emulsifier, and an oleaginous fluid, and mixing to form an oil external emulsion. A wellbore servicing fluid containing an oil external emulsion comprising a proppant, an oil external phase comprising an oleaginous fluid, an aqueous internal phase, a nanomaterial, and an emulsifier. A well servicing system is also provided.

### BACKGROUND

The present disclosure generally relates to fluids for use in subterranean applications and methods of making and using same. More particularly, this disclosure relates to fracturing fluids stabilized via the incorporation therein of nanomaterials, and utilizing such fluids to transport proppant particulates in a subterranean formation.

Subterranean wells (e.g., hydrocarbon fluid producing wells and water producing wells) are often stimulated by hydraulic fracturing treatments. In a typical hydraulic fracturing treatment, a treatment fluid is pumped into a wellbore in a subterranean formation at a rate and pressure above the fracture gradient of the particular subterranean formation so as to create or enhance at least one fracture therein. Particulate solids (e.g., graded sand, bauxite, ceramic, nut hulls, and the like), or ‘proppant particulates’, are typically suspended in the treatment fluid or a second treatment fluid and deposited into the fractures while maintaining pressure above the fracture gradient. The proppant particulates are generally deposited in the fracture in a concentration sufficient to form a tight pack of proppant particulates, or ‘proppant pack’, which serves to prevent the fracture from fully closing once the hydraulic pressure is removed. By keeping the fracture from fully closing, the interstitial spaces between individual proppant particulates in the proppant pack form conductive pathways through which produced fluids may flow.

In traditional hydraulic fracturing treatments, the specific gravity of the proppant particulates may be high in relation to the treatment fluids in which they are suspended for transport and deposit in a target interval (e.g., a fracture). Therefore, the proppant particulates may settle out of the treatment fluid and fail to reach the target interval. For example, where the proppant particulates are to be deposited into a fracture, the proppant particulates may settle out of the treatment fluid and accumulate only or substantially at the bottommost portion of the fracture, which may result in complete or partial occlusion of the portion of the fracture where no proppant particulates have collected (e.g., at the top of the fracture). As such, fracture conductivity and production over the life of a subterranean well may be substantially impaired if proppant particulates settle out of the treatment fluid before reaching their target interval within a subterranean formation.

One way to compensate for proppant particulate settling is to introduce the proppant particulates into the fracture in a viscous gelled fluid. Gelled fluids typically require high concentrations of gelling agents and/or crosslinker, particularly when transporting high concentrations of proppant particulates in order to maintain them in suspension. As many gelling and crosslinking agents are used in a variety of fluids within and outside of the oil and gas industry, their demand is increasing while their supply is decreasing. Therefore, the cost of gelling and crosslinking agents is increasing, and consequently, the cost of hydraulic fracturing treatments requiring them is also increasing. Additionally, the use of gelling and crosslinking agents may result in premature viscosity increases that may cause pumpability issues or problems with subterranean operations equipment.

Another method of compensating for the settling nature of proppant particulates is the introduction of gas-generating mechanisms that introduce sufficient gas to increase proppant particulate buoyancy within the treatment fluid. However, the gas is often generated at unwanted intervals within the subterranean formation, thereby failing to adequately keep the proppant particulates suspended in the treatment fluid until they reach the target interval. Additionally, gas may be generated partially at unwanted intervals and partially at the desired interval, such that the amount of gas generated at the desired interval is insufficient to increase the buoyancy of the proppant particulates to overcome settling forces.

The degree of success of a hydraulic fracturing operation depends, at least in part, upon fracture conductivity after the fracturing operation has ceased and production commenced. Accordingly, an ongoing need exists for methods and compositions which provide for enhanced hindering of the settling of proppant particulates in a wellbore treatment fluid, particularly during fracturing and conformance applications.

### BRIEF DESCRIPTION OF THE DRAWING

The following FIGURE is included to illustrate certain aspects of the present disclosure, and should not be viewed as providing exclusive embodiments. The subject matter disclosed herein is capable of considerable modification, alteration, and equivalents in form and function, as will occur to one having ordinary skill in the art and having the benefit of this disclosure.

FIG. 1 depicts an embodiment of a system configured for delivering the wellbore treatment fluids of the embodiments described herein to a downhole location.

### DETAILED DESCRIPTION

The present disclosure provides a wellbore treatment fluid composition for improved transportation of proppants in vertical and horizontal wells and/or in a fracture, as well as methods of making and using the wellbore treatment fluid. The composition described herein comprises an oil external emulsion into which are incorporated nanomaterials (e.g., carbon nanomaterials) which serve to enhance the fluid properties while efficiently enabling proppant placement in fractures.

Herein disclosed is a method of servicing in a wellbore in a subterranean formation, the method comprising: preparing a wellbore servicing fluid comprising proppant particulates suspended in an oil external emulsion, wherein the oil external emulsion comprises an oleaginous fluid external phase, an aqueous internal phase, a nanomaterial, and an emulsifier; and introducing the wellbore servicing fluid into the wellbore in the subterranean formation. In embodiments, the nanomaterial is selected from the group consisting of graphite-derived carbon nanomaterials, silica, cellulose, latex, and combinations thereof. In embodiments, the carbon nanomaterial comprises one or more component selected from the group consisting of graphene nanoparticles, functionalized graphene nanoparticles, chemically-modified graphene nanoparticles, covalently-modified graphene nanoparticles, graphene oxide nanoparticles, and combinations thereof. The carbon nanomaterial can have at least one dimension of less than about 50 nm. In embodiments, the nanomaterial is a hydrophobically-modified nanomaterial.

In embodiments, the wellbore servicing fluid comprises from about 0.05% (w/v) to about 2% (w/v) of the nanomaterial. In embodiments, the oil external emulsion comprises comprises less than 10 volume percent of the oleaginous fluid. In embodiments, the oil external emulsion comprises comprises less than or equal to about 5 volume percent of the oleaginous fluid. In embodiments, the wellbore servicing fluid comprises from about 0.1 ppg (12 kg/m³) to about 10 ppg (1200 kg/m³) of the proppant, based on the total volume of the wellbore servicing fluid. In embodiments, the wellbore servicing fluid further comprises a surface modifying agent. In other embodiments, the wellbore servicing fluid comprises no surface modifying agent. In embodiments, the wellbore servicing fluid further comprises a co-emulsifier. In embodiments, the wellbore servicing fluid is stable for at least 90 minutes at 200° F. (93.3° C.). In embodiments, the wellbore in the subterranean formation comprises at least one fracture, and the step of introducing the wellbore servicing fluid comprising the proppant particulates into the wellbore in the subterranean formation further comprises placing at least a portion of the proppant particulates into the at least one fracture.

Also disclosed herein is a method of forming a wellbore servicing fluid, the method comprising: dispersing a nanomaterial in water; combining the aqueous dispersed nanomaterial with a proppant, an emulsifier, and an oleaginous fluid; and mixing to form an oil external emulsion. In embodiments, the nanomaterial comprises one or more component selected from the group consisting of graphene nanoparticles, functionalized graphene nanoparticles, chemically-modified graphene nanoparticles, covalently-modified graphene nanoparticles, graphene oxide nanoparticles, and combinations thereof. In embodiments, the wellbore servicing fluid comprises from about 0.05% (w/v) to about 2% (w/v) of the nanomaterial. In embodiments, the oil external emulsion comprises less than 10 volume percent of the oleaginous fluid. In embodiments, the oil external emulsion comprises less than or equal to about 5 volume percent of the oleaginous fluid. In embodiments, the wellbore servicing fluid comprises from about 0.1 ppg (12 kg/m³) to about 10 ppg (1200 kg/m³) of the so proppant, based on the total volume of the wellbore servicing fluid. In embodiments, the method of forming the wellbore servicing fluid further comprises coating the proppant with a surface modifying agent prior to combining with the aqueous dispersed nanomaterial, the oleaginous fluid, and the emulsifier. In other embodiments, the wellbore servicing fluid comprises no surface modifying agent.

Also disclosed herein is a wellbore servicing fluid comprising: an oil external emulsion comprising a proppant, an oil external phase comprising an oleaginous fluid, an aqueous internal phase, a nanomaterial, and an emulsifier. In embodiments, the nanomaterial is selected from the group consisting of graphite-derived carbon nanomaterials, silica, cellulose, latex, and combinations thereof. In embodiments, the carbon nanomaterial comprises one or more component selected from the group consisting of graphene nanoparticles, functionalized graphene nanoparticles, chemically-modified graphene nanoparticles, covalently-modified graphene nanoparticles, graphene oxide nanoparticles, and combinations thereof. In embodiments, the carbon nanomaterial has at least one dimension less than about 50 nm. In embodiments, the nanomaterial is a hydrophobically-modified nanomaterial. In embodiments, the wellbore servicing fluid comprises from about 0.05% (w/v) to about 2% (w/v) of the nanomaterial. In embodiments, the oil external emulsion comprises less than 10 volume percent of the oleaginous fluid. In embodiments, the oil external emulsion comprises less than or equal to about 5 volume percent of the oleaginous fluid. In embodiments, the wellbore servicing fluid comprises from about 0.1 ppg (12 kg/m³) to about 10 ppg (1200 kg/m³) of the proppant, based on the total volume of the wellbore servicing fluid. In embodiments, the wellbore servicing fluid further comprises a surface modifying agent coated onto at least a portion of the proppant. In embodiments, the wellbore servicing fluid comprises no surface modifying agent. In embodiments, the wellbore servicing fluid further comprises a co-emulsifier. In embodiments, the wellbore servicing fluid is stable for at least 90 minutes at 200° F. (93.3° C.).

Also disclosed herein is a well servicing system comprising: a well treatment apparatus, including at least one mixer and a pump, configured to: disperse a nanomaterial in water to form an aqueous dispersed nanomaterial; combine the aqueous dispersed nanomaterial with a proppant, an emulsifier, and an oleaginous fluid to form a pre-emulsified fluid; mix the pre-emulsified fluid to form an oil external emulsified fluid; and introduce the oil external emulsified fluid into a subterranean formation.

General Measurement Terms

Unless otherwise specified or unless the context otherwise clearly requires, any ratio or percentage means by volume.

If there is any difference between U.S. or Imperial units, U.S. units are intended.

Unless otherwise specified, mesh sizes are in U.S. Standard Mesh.

The micrometer (μm) may sometimes be referred to herein as a micron.

The conversion between pound per gallon (lb/gal or ppg) and kilogram per cubic meter (kg/m³) is: 1 lb/gal=(1 lb/gal)×(0.4536 kg/lb)×(gal/0.003785 m³)=120 kg/m³.

The features and advantages provided by the fracturing fluid of this disclosure will be readily apparent to those skilled in the art upon a reading of the following description of the embodiments. As noted hereinabove, the present disclosure relates to fracturing fluid systems comprising emulsions stabilized via the incorporation of nanomaterials. More specifically, the present disclosure provides, in embodiments, wellbore treatment fluids that exhibit enhanced stability relative to treatment fluids absent the nanomaterials.

Although the description that follows is primarily directed to fracturing fluids and conductivity enhancement via utilization of such fluids, wellbore treatment fluids containing like particulates (e.g., gravel packing fluids comprising gravel) may also be stabilized by making use of the present disclosure.

As noted hereinabove, the present disclosure also provides methods of forming the herein-disclosed wellbore treatment fluids, as detailed further hereinbelow. Oil external emulsions according to the present disclosure may advantageously be formed via the introduction of the nanomaterial and/or proppant thereto prior to pumping downhole. In this manner, the emulsion structure of the treatment fluid and the distribution of the particulate (e.g., proppant) therein may be stabilized.

As noted hereinabove, the present disclosure also describes methods of using wellbore treatment fluids according to this disclosure. In some embodiments, the methods comprise providing a wellbore treatment fluid comprising an external oil phase, a particulate (e.g., proppant, gravel), water, and a nanomaterial according to this disclosure, and placing the wellbore treatment fluid in a subterranean formation via a wellbore penetrating the subterranean formation. Although referred to herein as a ‘treatment’ fluid, it is to be understood that the nanomaterial stabilized emulsion according to this disclosure may be particularly suitable for use in fracturing applications, conformance applications, and the like.

Of the many advantages of the present disclosure, only a few of which are discussed or alluded to herein, the present disclosure generally provides facile methods for stabilizing emulsions suitable for use during fracturing applications. The herein-disclosed nanomaterial based emulsified fluid system provides for efficient proppant transportation. Fracturing fluids according to this disclosure may exhibit improved stability, sometimes at higher than previously considered temperatures. For example, the nanomaterial-stabilized fracturing fluids of this disclosure may exhibit enhanced stability relative to fracturing fluids absent the nanomaterials, and/or may be stable at higher temperatures than fracturing fluids absent the nanomaterials. For example, in embodiments, the fracturing fluids of this disclosure are stable for 50 to 140% longer than fracturing fluids absent the nanomaterials, and in embodiments, the disclosed fracturing fluids are stable at temperatures of greater than 180° F. (82.2° C.), 200° F. (93.3° C.), 250° F. (121.1° C.), 300° F. (148.9° C.), or 350° F. (176.7° C.).

Nanomaterial

A wellbore treatment fluid according to this disclosure comprises a nanomaterial. Nanomaterials are known to stabilize emulsions by establishing strong non covalent networks at solid/liquid, and liquid/liquid interfaces. Graphite based nanomaterials have received much attention in the recent years due to the gradual decrease in their cost and global availability. The nanomaterial of the herein-disclosed wellbore treatment fluids comprises particulate having at least one dimension in the nanometer range. Although described with reference to graphene, various nanomaterials can be utilized to form wellbore treatment fluids according to this disclosure, and such nanomaterials are within the scope of this disclosure. For example, in embodiments, the nanomaterial comprises silica, latex, graphite-derived carbon nanomaterials, such as graphite powder, hybrids of the aforementioned materials, and/or combinations thereof. By way of non-limiting example, hydrophobically-modified nanomaterials may provide improved properties in certain applications.

In embodiments, the nanomaterial comprises graphene nanoparticles. The graphene nanoparticles may be unmodified, or modified to alter at least one property thereof. For example, in embodiments, the graphene nanoparticles may be surface modified graphene nanoparticles. In embodiments, the graphene nanoparticles comprise graphene, functionalized graphene, chemically-modified graphene, covalently-modified graphene, graphene oxide, or a combination thereof. In embodiments, the nanomaterial comprises graphene nanoparticles that have not been modified. In embodiments, the nanomaterial comprises one in the category of NTE (Negative Thermal Expansion), such as, but not limited to, ZrW₂O₈, ZrV₂O₇, Sc₂(WO₄)₃, ZbZr(PO₄)₃, etc.

It has been discovered that graphene nanoparticles may improve the stability of oil external emulsions suitable for use in hydraulic fracturing applications. The nanofluids for these types of applications may be designed by adding nano-composites and/or organic and inorganic nano-particulate materials, such as graphene nanoparticles. Graphene is an allotrope of carbon, the structure of which is a planar sheet of sp2-bonded graphite atoms that are densely packed in a 2-dimensional honeycomb crystal lattice. The term ‘graphene’ is used herein to include particles that may contain more than one atomic plane, but still comprise a layered morphology, i.e. one in which one of the dimensions is significantly smaller than the other two. The typical maximum number of monoatomic-thick layers in the graphene nanoparticles here may be about fifty (50). The structure of graphene is hexagonal, and graphene is often referred to as a 2-dimensional (2-D) material. The 2-D structure of the graphene nanoparticles is often paramount to useful applications involving graphene nanoparticles. The applications of graphite, the 3-D version of graphene, are not equivalent to the 2-D applications of graphene. Fundamental properties, such as electrical conductivity, Young's modulus, thermal conductivity, dielectric properties, and those previously mentioned of graphene have been measured and compare well with those of carbon nanotubes. The 2-D morphology, however, provides significant benefits when dispersed in complex fluids, such as multi-phasic fluids or emulsions. Unique to this application is the engineering of the graphene dispersion within the different phases of the fluid, e.g., oil and water, to achieve desired properties.

In the present context, graphene nanoparticles may have at least one dimension less 50 nm, although other dimensions may be larger than this. In a non-limiting embodiment, the graphene nanoparticles may have one dimension less than 30 nm, or alternatively 10 nm. In embodiments, the smallest dimension of the graphene nanoparticles may be less than 5 nm, although the length of the graphene nanoparticles may be much longer, for instance 100 nm, 1000 nm, or more. In some embodiments, the emulsion comprises particles having a size in the range of from about 1 μm to about 20 μm. For example, without limitation, in some embodiments, the emulsion comprises graphite powder. The incorporation of such graphene nanoparticles and/or graphite powder is to be understood to be within the scope of the fluids disclosed herein.

It should be understood that surface-modified graphene nanoparticles may find utility in the compositions and methods herein. ‘Surface-modification’ is defined here as the process of altering or modifying the surface properties of a particle by any means, including but not limited to physical, chemical, electrochemical or mechanical means. Such modification may be performed with the intent to provide a unique desirable property or combination of properties to the surface of the graphene nanoparticle, which differs from the properties of the surface of the unprocessed graphene nanoparticle. Functionalized graphene nanoparticles are defined herein as those which have had their edges or surfaces modified to contain at least one functional group including, but not necessarily limited to, sulfonate, sulfate, sulfosuccinate, thiosulfate, succinate, carboxylate, hydroxyl, glucoside, ethoxylate, propoxylate, phosphate, ether, amines, amides, ethoxylate-propoxylate and combinations thereof.

The enormous surface areas per volume may significantly increase the interaction of the graphene nanoparticles with the matrix or surrounding fluid. This surface area may serve as sites for bonding with functional groups and can influence crystallization, chain entanglement, and morphology, and thus can generate a variety of properties in the matrix or fluid. In the present context, the fluid may include the base fluid, such as but not limited to a drilling fluid, a completion fluid, a production fluid, or a servicing fluid. For instance, it is anticipated that graphene nanoparticles and conventional polymers or copolymers may be linked or bonded together directly or through certain intermediate chemical linkages to combine some of the advantageous properties of each. Additionally, because of the very large surface area to volume present with graphene nanoparticles, it is expected that in most, if not all cases, much less proportion of graphene nanoparticles need be employed relative to micron-sized additives conventionally used to achieve or accomplish a similar effect.

Similarly, polymers may be connected with the graphene nanoparticles in particular ways, such as by crosslinking-type connections, hydrogen bonding, covalent bonding and the like. Such graphene nanoparticle-polymer hybrids may use graphene nanoparticles as polymer-type building blocks in conventional copolymer-type structures, such as block copolymers, graft copolymers, and the like. The nanoparticles utilized herein are synthetically formed graphene nanoparticles where size, shape and chemical composition may be carefully controlled. The graphene nanoparticles may be functionally modified to introduce chemical functional groups thereon, as known to those of skill in the art. For example, by way of nonlimiting example, the graphene nanoparticles with may be reacted with a peroxide such as diacyl peroxide to add acyl groups which may in turn be reacted with diamines to provide amine functionality, which may be further reacted, as desired and known to those of skill in the art.

It should be understood that the graphene nanoparticles may have more than one type of functional group, making them multifunctional. Multifunctional graphene nanoparticles may be useful for simultaneous applications, as will be apparent to those of skill in the art.

A wellbore treatment fluid according to this disclosure may comprise an amount of nanoparticle suitable to enhance the stability for a given application. It will be apparent to one of skill in the art, upon reading this disclosure, how to determine such a suitable amount of nanomaterial. However, without limitation, in embodiments, a wellbore treatment fluid according to this disclosure may contain from about 0.01% (w/v) to about 5% (w/v), from about 0.1% (w/v) to about 5% (w/v), from about 0.05% (w/v) to about 2% (w/v), or from about 0.05% (w/v) to about 0.5% (w/v) of the nanomaterial. In embodiments, a wellbore treatment fluid according to this disclosure contains greater than or equal to about 0.05, 0.1, 0.2, 0.3, 0.4, or 0.5% (w/v) of the nanomaterial. In embodiments, a wellbore treatment fluid according to this disclosure contains less than or equal to about 0.5, 0.4, 0.3, 0.2, 0.1, or 0.05% (w/v) of the nanomaterial.

The nanomaterial may comprise graphene nanoparticles having a specific gravity in the range of from about 1 to about 3 g/cc, from about 1.5 to about 2.5 g/cc, or from about 2 to about 2.5 g/cc. In embodiments, the graphene nanoparticles may have a specific gravity of less than, greater than, or equal to about 1, 2, or 3 g/cc. In embodiments, the nanomaterial may comprise graphene nanoparticles having a plate dimension in the range of from about 4-10, 5-9, or 6-8 nm thick, and/or 2/0.1 wide. In embodiments, the graphene nanomaterial has a surface area of greater than or equal to about 500, 600, 650, 700, or 750 m²/g. In embodiments, the graphene nanoparticles have a tensile strength of at least or equal to about 1, 2, 3, 4, or 5 GPa.

Particulate/Proppant

The applications in which the methods of the present invention may be used include any subterranean operation where suspending proppant particulates, or other solid particles, may be of benefit. In some embodiments, the oil external treatment fluids of the present invention may be utilized to transport proppant particulates, which may be coated or uncoated with a surface modification agent in various embodiments, into an at least one fracture within a subterranean formation. Therein, the proppant particulates may form a proppant pack capable of holding open the fracture during production of the well.

Wellbore treatment fluids according to this disclosure comprise a particulate. In embodiments, the particulate is a proppant comprising sized particles mixed with the fracturing fluid to hold fractures open after a hydraulic fracturing treatment. The proppant particulates for use in the methods of the present invention may comprise any material suitable for use in subterranean operations. The proppant may be natural or synthetic, or may comprise a combination of natural and synthetic material. Suitable materials for the proppant particulates include, but are not limited to, sand; bauxite; ceramic materials; glass materials; polymer materials; polytetrafluoroethylene materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; and combinations of one or more thereof. Suitable composite particulates may comprise a binder and a filler material wherein suitable filler materials include, but are not limited to, silica; alumina; fumed carbon; carbon black; graphite; mica; titanium dioxide; meta-silicate; calcium silicate; kaolin; talc; zirconia; boron; fly ash; hollow glass microspheres; solid glass; and any combination thereof.

The mean proppant particulate size generally may range from about 2 mesh to about 400 mesh on the U.S. Sieve Series; however, in certain circumstances, other mean proppant particulate sizes may be desired and will be entirely suitable for practice according to the present disclosure. In embodiments, the particulate size distribution range is one or more of 6/12, 8/16, 12/20, 16/30, 20/40, 30/50, 40/60, 40/70, or 50/70 mesh. It should be understood that the term ‘proppant particulate’, as used in this disclosure, includes all known shapes of materials, including substantially spherical materials; fibrous materials; polygonal materials (e.g., cubic materials); and any combination thereof. Moreover, fibrous materials, that may or may not be used to bear the pressure of a closed fracture, may be included in certain embodiments of the present invention. In certain embodiments, the particulates may be present in the oil external treatment fluid of the present invention in an amount in the range of from about 0.5 pounds per gallon or ppg (60 kg/m³) to about 30 ppg (3600 kg/m³), from about 3 ppg (360 kg/m³) to about 20 ppg (2400 kg/m³), from about 5 pounds per gallon (600 kg/m³) to about 10 ppg (1200 kg/m³) by volume of the treatment fluid.

Aqueous and Oil Phases

Wellbore treatment fluids according to this disclosure comprise an aqueous phase comprising an aqueous fluid and an oil phase comprising an oleaginous fluid or hydrocarbon. In embodiments, the wellbore treatment fluid is water-based, and comprises an aqueous base fluid. In embodiments, the wellbore treatment fluid of this disclosure is an oil external emulsion comprising an oil external phase and an aqueous internal phase.

Aqueous Phase: As used herein, the term ‘aqueous fluid’ refers to a material comprising water or a water-miscible but oleaginous fluid-immiscible compound. Illustrative aqueous fluids suitable for use in embodiments of this disclosure include, for example, fresh water, sea water, a brine containing at least one dissolved organic or inorganic salt, a liquid containing water-miscible organic compounds, and the like.

The aqueous fluid or base fluid of the present embodiments can generally be from any source, provided that the fluids do not contain components that might adversely affect the stability and/or performance of the wellbore treatment fluids of the present disclosure. In various embodiments, the aqueous fluid can comprise fresh water, salt water, seawater, brine, or an aqueous salt solution. In some embodiments, the aqueous fluid can comprise a monovalent brine or a divalent brine. Suitable monovalent brines can include, for example, sodium chloride brines, sodium bromide brines, potassium chloride brines, potassium bromide brines, and the like. Suitable divalent brines can include, for example, magnesium chloride brines, calcium chloride brines, calcium bromide brines, and the like. In some embodiments, the aqueous base fluid can be a high density brine. As used herein, the term ‘high density brine’ refers to a brine that has a density of about 9.5-10 lbs/gal or greater (1.1 g/cm³-1.2 g/cm³ or greater).

Oil Phase: A wellbore treatment fluid of this disclosure comprises an oil phase. In embodiments, a wellbore treatment fluid according to this disclosure comprises an oil external phase. The oil phase comprises an oleaginous fluid, which may include one or more hydrocarbon. As used herein, the term ‘oleaginous fluid’ refers to a material having the properties of an oil or like non-polar hydrophobic compound. Illustrative oleaginous fluids suitable for use in embodiments of this disclosure include, for example, (i) esters prepared from fatty acids and alcohols, or esters prepared from olefins and fatty acids or alcohols; (ii) linear alpha olefins, isomerized olefins having a straight chain, olefins having a branched structure, isomerized olefins having a cyclic structure, and olefin hydrocarbons; (iii) linear paraffins, branched paraffins, poly-branched paraffins, cyclic paraffins and isoparaffins; (iv) mineral oil hydrocarbons; (v) glyceride triesters including, for example, rapeseed oil, olive oil, canola oil, castor oil, coconut oil, corn oil, cottonseed oil, lard oil, linseed oil, neatsfoot oil, palm oil, peanut oil, perilla oil, rice bran oil, safflower oil, sardine oil, sesame oil, soybean oil and sunflower oil; (vi) naphthenic compounds (cyclic paraffin compounds having a formula of CₙH₂ₙ where n is an integer ranging between about 5 and about 30); (vii) diesel; (viii) aliphatic ethers prepared from long chain alcohols; and (ix) aliphatic acetals, dialkylcarbonates, and mixtures thereof. As used herein, fatty acids and alcohols or long chain acids and alcohols refer to acids and alcohols containing about 6 to about 22 carbon atoms, or about 6 to about 18 carbon atoms, or about 6 to about 14 carbon atoms. In some embodiments, such fatty acids and alcohols have about 6 to about 22 carbon atoms comprising their main chain. One of ordinary skill in the art will recognize that the fatty acids and alcohols may also contain unsaturated linkages.

In embodiments, in a wellbore treatment fluid according to this disclosure, an oleaginous fluid external phase and an aqueous fluid internal phase are present in a ratio of less than about 50:50. This ratio is commonly stated as the oil-to-water ratio (OWR). That is, in the present embodiments, a wellbore treatment fluid having a 50:50 OWR comprises 50% oleaginous fluid external phase and 50% aqueous fluid internal phase. In embodiments, drilling fluids according to this disclosure have an OWR ranging between about 5:95 to about 35:65, including all sub-ranges therein between. In embodiments, drilling fluids of this disclosure have an OWR ranging between about 1:99 and about 10:90, including all sub-ranges therein between. In embodiments, the drilling fluids have an OWR of about 10:90 or less. In embodiments, the drilling fluids have an OWR of about 5:95 or less. One of ordinary skill in the art will recognize that lower OWRs can more readily form emulsions that are suitable for suspending sand and other proppants therein. However, one of ordinary skill in the art will also recognize that an OWR that is too low may prove overly viscous for downhole pumping.

In embodiments, an oil external emulsion treatment fluid according to this disclosure comprises a less than conventional volume percentage of oil. For example, in embodiments, a wellbore treatment fluid according to this disclosure comprises from about 1 to about 10, from about 2 to about 9, or from about 3 to about 8 volume percent oil, based on the total volume of the treatment fluid. In embodiments, a wellbore treatment fluid according to this disclosure comprises less than or equal to about 30, 25, 20, 15, 10, 9, 8 7, 6, 5, 4, or 3 volume percent oil, based on the total volume of the treatment fluid.

Other Additives

A wellbore treatment fluid of this disclosure may optionally comprise any number of additional additives known to those of skill in the art to be suitable for use in such wellbore treatment fluids. Examples of such additional additives include, without limitation, surfactants, gelling agents, fluid loss control agents, corrosion inhibitors, rheology control modifiers or thinners, viscosity enhancers, temporary viscosifying agents, filtration control additives, high temperature/high pressure control additives, emulsification additives, surfactants, alkalinity agents, pH buffers, gases, nitrogen, carbon dioxide, surface modifying agents, tackifying agents, foamers, scale inhibitors, catalysts, clay control agents, biocides, bactericides, friction reducers, antifoam agents, bridging agents, dispersants, flocculants, H₂S scavengers, CO₂ scavengers, oxygen scavengers, friction reducers, breakers, relative permeability modifiers, resins, wetting agents, coating enhancement agents, filter cake removal agents, surfactants, defoamers, shale stabilizers, oils, and the like. One or more of these additives (e.g., bridging agents) may comprise degradable materials that are capable of undergoing irreversible degradation downhole. A person skilled in the art, with the benefit of this disclosure, will recognize the types of additives that may be included in the drilling fluids of the present disclosure for a particular application, without undue experimentation.

Emulsifier(s): A wellbore treatment fluid according to this disclosure may comprise one or more emulsifiers. Examples of suitable emulsifiers may include, but are not limited to, surfactants, proteins, hydrolyzed proteins, lipids, glycolipids, nanosized particulates (e.g., fumed silica), fatty alcohol sulphates, fatty alcohol ether-sulphates, alkyl sulphonates, carboxymethylated fatty alcohol oxethylates, fatty alcohol (ether) phosphates, fatty alcohol ethersulphosuccinates, alkyl betaines, fatty alcohol oxethylates, fatty acid oxethylates, fatty acid esters of polyhydric alcohols or of ethoxylated polyhydric alcohols (sorbitan esters), sugar fatty acid esters, fatty acid partial glycerides, glycerides with fatty acids and polybasic carboxylic acids, and the like.

Surface Modifying Agents: A wellbore treatment fluid according to this disclosure may comprise a surface modifying and/or tackifying agent. Suitable surface modifying agents are known to those of skill in the art; suitable surface modifying agents may be as provided in U.S. Pat. No. 9,038,717, to Halliburton Energy Services, Inc. In embodiments, a surface modifying agent is coated onto the proppant particulates, for example as described in the Example hereinbelow. In embodiments, however, a wellbore treatment fluid according to this disclosure does not comprise a surface modifying agent, or a tackifying agent, or comprises neither.

Method of Making Wellbore Treatment Fluid

Also disclosed herein is a method of making the wellbore treatment fluid of this disclosure. The method comprises dispersing a nanomaterial, as provided hereinabove, in water; combining the aqueous dispersed nanomaterial with a proppant, an emulsifier, and oil, as provided hereinabove; and stirring to form an oil external emulsion. It has been surprisingly discovered that the order of addition of carbon nanomaterials (i.e., dispersing the nanomaterial in the water prior to combination thereof with the balance of the components) alters the properties of the emulsion, including, but not limited to, the stability thereof.

In embodiments, the method of forming the wellbore treatment fluid according to this disclosure further comprises coating the proppant with a surface modifying agent prior to combining the aqueous dispersed nanomaterial with the SMA-coated proppant and the emulsifier. In embodiments, however, the wellbore servicing fluid comprises no surface modifying agent.

As noted hereinabove, the wellbore servicing fluid can comprise from about 0.05% (w/v) to about 2% (w/v) of the nanomaterial. The oil external emulsion can comprise less than 30, 25, 20, 15, 10, 9, 8, 7, 6, 5, 4, or 3 volume percent oil. The wellbore servicing fluid can comprise from about 0.5 ppg (60 kg/m³) to about 10 ppg (1200 kg/m³) of the proppant, based on the total volume of the wellbore servicing fluid. The wellbore servicing fluid can comprise from about 0.1 ppg (12 kg/m³) to about 10 ppg (1200 kg/m³) of the proppant, based on the total volume of the wellbore servicing fluid.

As noted above, the nanomaterials and/or proppant particulates may advantageously be incorporated in a wellbore treatment fluid according to this disclosure prior to introduction of the wellbore treatment fluid in a subterranean formation. Such wellbore treatment fluids may be formulated at a production facility and mixed by applying a shearing force to the treatment fluid. Application of the shearing force may result in formation of an emulsion which is stabilized by the nanomaterial. Once formed, the emulsion may be stable in the absence of a shearing force, such that the wellbore treatment fluids of the present disclosure have a reduced tendency toward proppant precipitation. In embodiments, the nanomaterial inhibits and/or reduces separation of the proppant particles for at least or equal to about 60, 70, 80, 90, 100, 110, or 120 minutes.

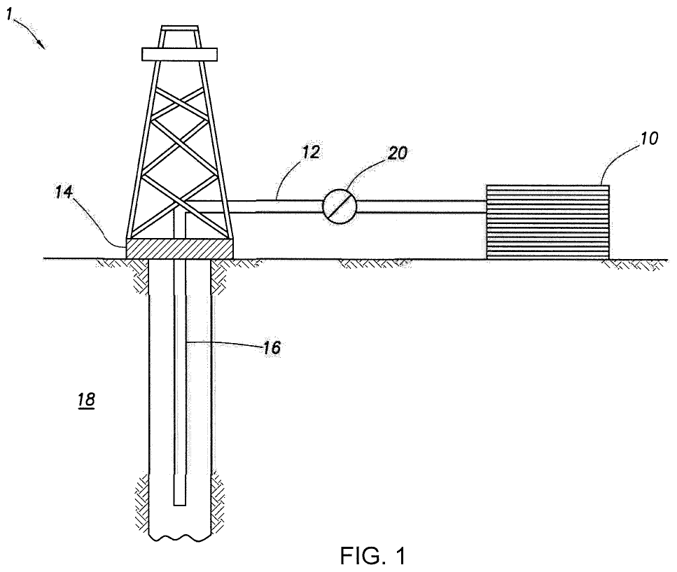

In embodiments, the disclosed wellbore treatment fluid may be prepared at a well site or at an offsite location. Once prepared, a treatment fluid of the present disclosure may be placed in a tank, bin, or other container for storage and/or transport to the site where it is to be used. In other embodiments, a treatment fluid of the present disclosure may be prepared on-site, for example, using continuous mixing, on-the-fly mixing, or real-time mixing methods. In certain embodiments, these methods of mixing may include methods of combining two or more components wherein a flowing stream of one element is continuously introduced into flowing stream of another component so that the streams are combined and mixed while continuing to flow as a single stream as part of the on-going treatment. The system depicted in FIG. 1 (described further hereinbelow) may be one embodiment of a system and equipment used to accomplish on-the-fly or real-time mixing.

Methods of Use

Also disclosed herein are methods of introducing a wellbore treatment fluid according to this disclosure into a wellbore. The methods of the present disclosure may be employed in any subterranean application where a treatment fluid of this disclosure may be suitable. In an embodiment, a method of treating a wellbore comprises providing a wellbore treatment fluid according to this disclosure, and using the wellbore treatment fluid during a stimulating operation. The treatment fluid may be used in conjunction with any downhole operation for which it is suitable, as will be apparent to those of skill in the art.

The methods and wellbore fluid compositions of the present disclosure may be used during or in conjunction with an operation in a portion of a subterranean formation and/or wellbore, and may be particularly suitable for hydraulic fracturing applications and/or conformance applications. For example, the methods and/or compositions of the present disclosure may be used in the course of hydraulic fracturing operations in which a herein-disclosed oil external emulsion fracturing fluid may be pumped at high pressure and rate into a reservoir interval to be treated, causing a vertical fracture(s) to open, thus enhancing conductivity.

The wellbore treatment fluids of the present disclosure may be provided and/or introduced into the wellbore in a subterranean formation using any method or equipment known in the art. In certain embodiments, a wellbore fluid of the present disclosure may be circulated in the wellbore using the same types of pumping systems and equipment at the surface that are used to introduce drilling fluids and/or other treatment fluids or additives into a wellbore penetrating at least a portion of the subterranean formation.

FIG. 1 shows an illustrative schematic of a system that can deliver treatment fluids of the embodiments disclosed herein to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which a treatment fluid of the embodiments disclosed herein may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

The invention having been generally described, the following Example is given as a particular embodiment of this disclosure and to demonstrate the practice and advantages thereof. It is to be understood that the Example is given by way of illustration only, and is not intended to limit the specification or the claims to follow in any manner.

### EXAMPLE

### Example 1: Effect of Graphene on Stability of Oil External Emulsion

Six samples of oil external emulsions were created as further described hereinbelow. Inventive samples 2, 4, and 6 comprised nanoparticles of graphene having a specific gravity of 2.12 g/cc, a plate dimension of 6-8 nm thick and 2/0.1 wide, a surface area of 750 m²/g, and a tensile strength of 5 GPa. Samples 1-4 comprised SAND WEDGE-NT® surface modifying agent available from Halliburton Energy Services in Houston, Tex. Samples 1, 2, 5, and 6 comprised PERFOR MUL™ emulsifier available from Halliburton Energy Services in Houston, Tex. Samples 3 and 4 comprised FACTANT™ emulsifier available from Halliburton Energy Services in Houston, Tex., along with the SAND WEDGE-NT® surface modifying agent, while Samples 5 and 6 comprised FACTANT™ as co-emulsifier along with the PERFOR MUL™ emulsifier.

Sample 1:

Fifty-nine (59) g (6 ppg (720 kg/m³)) of sand was coated with SAND WEDGE-NT® surface modifying agent available from Halliburton Energy Services in Houston, Tex., followed by the addition of 75 mL of water, 7.5 mL of LCA-1 paraffinic oil available from Halliburton Energy Services, in Houston, Tex., and 1.5 mL of PERFOR MUL™ emulsifier available from Halliburton Energy Services in Houston, Tex. The fluid was placed under over stirrer and stirring was continued at 1000 rpm for a few seconds.

Sample 2:

Sample 2 was created using the same protocol as described for Sample 1 above, with the exception of taking water dispersed with 0.1% w/v of graphene.

Sample 3:

Sample 3 was created using the same protocol as described for Sample 1 above, with the exception of replacing the PERFOR MUL™ emulsifier with FACTANT™ emulsifier available from Halliburton Energy Services in Houston, Tex.

Sample 4:

Sample 4 was created using the same protocol as described for Sample 3, with the exception of taking water dispersed with 0.1% w/v of graphene.

Sample 5:

Sample 5 was created using the same protocol as described for Sample 1, with the exception of utilizing FACTANT™ as co-emulsifier instead of SAND WEDGE-NT® surface modifying agent.

Sample 6:

Sample 6 was created using the same protocol as described for Sample 5, with the exception of taking water dispersed with 0.1% w/v of graphene.

The proppant suspension stability of each of the above the compositions of Samples 1-6 was tested in water bath at 200° F. (93.3° C.) and 0.1% (w/v) graphene (Table 1). Emulsion stability was measured by taking the emulsion comprising proppant in a glass bottle and maintaining the bottle in a water bath at 200° F. (93.3° C.) until it broke. Breaking of the emulsion was determined by periodically measuring the volume of water generated versus time. For temperatures above 200° F. (93.3° C.), emulsion comprising proppant was taken in a graduated glass liner/cylinder, followed by application of a pressure of about 600 psi in an autoclave. Timely removal and measurement of the generated water volume indicates the emulsion stability.

TABLE 1
Proppant Suspension Stability for Various Formulations

| | | | | Duration | |
|---|---|---|---|---|---|
| | | | | for | |
| | | | With | Forming | Sta- |
| Sample | | | Graph- | Emulsion, | bility, |
| Number | Emulsifier | SMA | ene | s | min |
| 1 | PERFORMUL ™ | SAND | No | 5-10 | ~60 |
| | | WEDGE- | | | |
| | | NT ® | | | |
| 2 | PERFORMUL ™ | SAND | Yes | 5-10 | ~90 |
| | | WEDGE- | | | |
| | | NT ® | | | |
| 3 | FACTANT ™ | SAND | No | 5-10 | ~90 |
| | | WEDGE- | | | |
| | | NT ® | | | |
| 4 | FACTANT ™ | SAND | Yes | 5-10 | ~180 |
| | | WEDGE- | | | |
| | | NT ® | | | |
| 5 | PERFORMUL ™ | FACTANT ™ | No | 5-10 | ~50 |
| 6 | PERFORMUL ™ | FACTANT ™ | Yes | 5-10 | ~120 |

As can be seen from the data in Table 1, the emulsion stability improved in each case when carbon nanomaterials (i.e. graphene particles) were added. The formed emulsions were able to successfully carry proppant and were comparatively more stable when prepared with the graphene nanomaterials.

The present disclosure is well adapted to attain the ends and advantages mentioned herein, as well as those that are inherent therein. A fracturing fluid comprising nanomaterial according to this disclosure may exhibit significantly enhanced stability, which may facilitate economic production and utilization of such wellbore treatment fluids, for example by enabling the usage of a greater variety of proppants, and/or usage over a wider temperature range and/or range of viscosities. Furthermore, the use of carbon-based nanomaterials having contrasting color to the emulsion fluid may enable improved quantification of proppant settling due to improved visualization of any settled proppant layer. The (low cost) emulsified fluid system and methods disclosed herein may provide improved proppant suspension for fracturing applications.

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Embodiments disclosed herein include:

A: A method of servicing a wellbore in a subterranean formation, the method comprising: providing a wellbore servicing fluid comprising proppant particulates suspended in an oil external emulsion, wherein the oil external emulsion comprises an oleaginous external phase, an aqueous internal phase, a nanomaterial, and an emulsifier; and introducing the wellbore servicing fluid into the wellbore in the subterranean formation.

B: A method of forming a wellbore servicing fluid, the method comprising: dispersing a nanomaterial in water; combining the aqueous dispersed nanomaterial with a proppant, an emulsifier, and an oleaginous fluid; and mixing to form an oil external emulsion.

C: A wellbore servicing fluid comprising: an oil external emulsion comprising a proppant, an oil external phase comprising an oleaginous fluid, an aqueous internal phase, a nanomaterial, and an emulsifier.

D: A well servicing system comprising: a well treatment apparatus, including at least one mixer and a pump, configured to: disperse a nanomaterial in water to form an aqueous dispersed nanomaterial; combine the aqueous dispersed nanomaterial with a proppant, an emulsifier, and an oleaginous fluid to form a pre-emulsified fluid; mix the pre-emulsified fluid to form an oil external emulsified fluid; and introduce the oil external emulsified fluid into a subterranean formation.

Each of embodiments A, B, C, D may have one or more of the following additional elements: Element 1: wherein the nanomaterial is selected from the group consisting of graphite-derived carbon nanomaterials, silica, cellulose, latex, and combinations thereof. Element 2: wherein the carbon nanomaterial comprises one or more component selected from the group consisting of graphene nanoparticles, functionalized graphene nanoparticles, chemically-modified graphene nanoparticles, covalently-modified graphene nanoparticles, graphene oxide nanoparticles, and combinations thereof. Element 3: wherein the carbon nanomaterial has at least one dimension of less than about 50 nm. Element 4: wherein the nanomaterial is a hydrophobically-modified nanomaterial. Element 5: wherein the wellbore servicing fluid comprises from about 0.05% (w/v) to about 2% (w/v) of the nanomaterial. Element 6: wherein the oil external emulsion comprises comprises less than or equal to about 10 volume percent of the oleaginous fluid. Element 7: wherein the the oil external emulsion comprises less than or equal to about 5 volume percent of the oleaginous fluid. Element 8: wherein the wellbore servicing fluid comprises from about 0.1 ppg (12 kg/m³) to about 10 ppg (1200 kg/m³) of the proppant, based on the total volume of the wellbore servicing fluid. Element 9: wherein the wellbore servicing fluid further comprises a surface modifying agent, which may be coated onto at least a portion of the proppant. Element 10: further comprising coating the proppant with a surface modifying agent prior to combining with the aqueous dispersed nanomaterial, the oleaginous fluid, and the emulsifier. Element 11: wherein the wellbore servicing fluid comprises no surface modifying agent. Element 12: wherein the wellbore servicing fluid further comprises a co-emulsifier. Element 13: wherein the wellbore servicing fluid is stable for at least 90 minutes at 200° F. (93.3° C.). Element 14: wherein the wellbore in the subterranean formation comprises at least one fracture, and wherein the step of introducing the wellbore servicing fluid comprising the proppant particulates into the wellbore in the subterranean formation further comprises placing at least a portion of the proppant particulates into the at least one fracture.

While preferred embodiments of the invention have been shown and described, modifications thereof can be made by one skilled in the art without departing from the teachings of this disclosure. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A method of servicing a wellbore in a subterranean formation, the method comprising:
providing a wellbore servicing fluid comprising proppant particulates suspended in an oil external emulsion, wherein the oil external emulsion comprises an oleaginous external phase, an aqueous internal phase, a nanomaterial, and an emulsifier; and
introducing the wellbore servicing fluid into the wellbore in the subterranean formation.

2. The method of claim 1, wherein the nanomaterial is selected from the group consisting of graphite-derived carbon nanomaterials, silica, cellulose, latex, and combinations thereof.

3. The method of claim 2, wherein the carbon nanomaterial comprises one or more component selected from the group consisting of graphene nanoparticles, functionalized graphene nanoparticles, chemically-modified graphene nanoparticles, covalently-modified graphene nanoparticles, graphene oxide nanoparticles, and combinations thereof.

4. The method of claim 2, wherein the carbon nanomaterial has at least one dimension of less than about 50 nm.

5. The method of claim 2, wherein the nanomaterial is a hydrophobically-modified nanomaterial.

6. The method of claim 1, wherein the wellbore servicing fluid comprises from about 0.05% (w/v) to about 2% (w/v) of the nanomaterial.

7. The method of claim 1, wherein the oil external emulsion comprises less than or equal to about 10 volume percent of the oleaginous fluid.

8. The method of claim 7, wherein the oil external emulsion comprises comprises less than or equal to about 5 volume percent of the oleaginous fluid.

9. The method of claim 1, wherein the wellbore servicing fluid comprises from about 0.1 ppg (12 kg/m³) to about 10 ppg (1200 kg/m³) of the proppant, based on the total volume of the wellbore servicing fluid.

10. The method of claim 1, wherein the wellbore servicing fluid further comprises a surface modifying agent.

11. The method of claim 1, wherein the wellbore servicing fluid comprises no surface modifying agent.

12. The method of claim 11, wherein the wellbore servicing fluid further comprises a co-emulsifier.

13. The method of claim 1, wherein the wellbore servicing fluid is stable for at least 90 minutes at 200° F. (93.3° C.).

14. The method of claim 1, wherein the wellbore in the subterranean formation comprises at least one fracture, and wherein the step of introducing the wellbore servicing fluid comprising the proppant particulates into the wellbore in the subterranean formation further comprises placing at least a portion of the proppant particulates into the at least one fracture.

15. A method of forming a wellbore servicing fluid, the method comprising:
dispersing a nanomaterial in water;
combining the aqueous dispersed nanomaterial with a proppant, an emulsifier, and an oleaginous fluid; and
mixing to form an oil external emulsion.

16. The method of claim 15, wherein the nanomaterial comprises one or more component selected from the group consisting of graphene nanoparticles, functionalized graphene nanoparticles, chemically-modified graphene nanoparticles, covalently-modified graphene nanoparticles, graphene oxide nanoparticles, and combinations thereof.

17. The method of claim 16, wherein the wellbore servicing fluid comprises from about 0.05% (w/v) to about 2% (w/v) of the nanomaterial.

18. The method of claim 15, wherein the oil external emulsion comprises less than or equal to about 10 volume percent of the oleaginous fluid.

19. The method of claim 18, wherein the oil external emulsion comprises less than or equal to about 5 volume percent of the oleaginous fluid.

20. The method of claim 15, wherein the wellbore servicing fluid comprises from about 0.1 ppg (12 kg/m³) to about 10 ppg (1200 kg/m³) of the proppant, based on the total volume of the wellbore servicing fluid.

21. The method of claim 15, further comprising coating the proppant with a surface modifying agent prior to combining with the aqueous dispersed nanomaterial, the oleaginous fluid, and the emulsifier.

22. The method of claim 15, wherein the wellbore servicing fluid comprises no surface modifying agent.

23. A wellbore servicing fluid comprising:
an oil external emulsion comprising a proppant, an oil external phase comprising an oleaginous fluid, an aqueous internal phase, a nanomaterial, and an emulsifier.

24. The wellbore servicing fluid of claim 23, wherein the nanomaterial is selected from the group consisting of graphite-derived carbon nanomaterials, silica, cellulose, latex, and combinations thereof.

25. The wellbore servicing fluid of claim 24, wherein the carbon nanomaterial comprises one or more component selected from the group consisting of graphene nanoparticles, functionalized graphene nanoparticles, chemically-modified graphene nanoparticles, covalently-modified graphene nanoparticles, graphene oxide nanoparticles, and combinations thereof.

26. The wellbore servicing fluid of claim 24, wherein the carbon nanomaterial has at least one dimension less than about 50 nm.

27. The wellbore servicing fluid of claim 24, wherein the nanomaterial is a hydrophobically-modified nanomaterial.

28. The wellbore servicing fluid of claim 23, wherein the wellbore servicing fluid comprises from about 0.05% (w/v) to about 2% (w/v) of the nanomaterial.

29. The wellbore servicing fluid of claim 23, wherein the oil external emulsion comprises less than or equal to about 10 volume percent of the oleaginous fluid.

30. The wellbore servicing fluid of claim 23, wherein the oil external emulsion comprises comprises less than or equal to about 5 volume percent of the oleaginous fluid.

31. The wellbore servicing fluid of claim 23, wherein the wellbore servicing fluid comprises from about 0.1 ppg (12 kg/m³) to about 10 ppg (1200 kg/m³) of the proppant, based on the total volume of the wellbore servicing fluid.

32. The wellbore servicing fluid of claim 23, wherein the wellbore servicing fluid further comprises a surface modifying agent coated onto at least a portion of the proppant.

33. The wellbore servicing fluid of claim 23, wherein the wellbore servicing fluid comprises no surface modifying agent.

34. The wellbore servicing fluid of claim 33, wherein the wellbore servicing fluid further comprises a co-emulsifier.

35. The wellbore servicing fluid of claim 23, wherein the wellbore servicing fluid is stable for at least 90 minutes at 200° F. (93.3° C.).

36. A well servicing system comprising:
a well treatment apparatus, including at least one mixer and a pump, configured to:
disperse a nanomaterial in water to form an aqueous dispersed nanomaterial;
combine the aqueous dispersed nanomaterial with a proppant, an emulsifier, and an oleaginous fluid to form a pre-emulsified fluid;
mix the pre-emulsified fluid to form an oil external emulsified fluid; and
introduce the oil external emulsified fluid into a subterranean formation.
